(19) United States
(12) Patent Application Publication
(10) Pub. No.: US 2008/0206437 A1
(43) Pub. Date: Aug. 28, 2008

(54) Combined Steaming/Poaching and Sauce Preparation

(75) Inventor: Bruce W. Perry, Canonsburg, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ALL-CLAD METALCRAFTERS LLC, Canonsburg, PA (US)

(21) Appl. No.: 12/038,441

(22) Filed: Feb. 27, 2008

Related U.S. Application Data
(60) Provisional application No. 60/904,071, filed on Feb. 27, 2007.

(51) Int. Cl. A23L 1/32; A47J 27/00; A23P 1/00; B65D 21/02

(52) U.S. Cl. 426/614; 220/573.1; 99/440; 220/23.88

(57) ABSTRACT

A combined egg poacher and sauce-making utensil having a pan for holding the water to be heated and a perforated steamer plate positioned in the pan spaced above the surface of the water in the pan. The perforated steamer plate holds removable egg cups for poaching eggs in a conventional manner. In one embodiment, a central portion of the steamer plate has a hole formed therethrough for receiving a sauce bowl removably positioned in the hole. The sauce bowl has a lid positioned thereon. A large main lid then covers the entire array of egg cups and sauce bowl with its lid. In another preferred embodiment, the sauce bowl may be formed integrally with the main lid or, conversely, the main lid may have a central aperture formed therethrough for receiving a separate sauce bowl and lid in the top of the main lid. In these arrangements, the hollandaise sauce or other sauce may be prepared separately while using the sauce bowl and then the eggs may be poached at a different time because the sauce generally takes longer to prepare than the cooking of the eggs.

### BACKGROUND OF THE INVENTION

1. Field of the Invention

The present invention relates to cookware and, more particularly, to a combined egg poacher/sauce-making utensil. More particularly, the invention is suitable for making poached eggs and hollandaise sauce for Eggs Benedict with the use of a single cooking utensil.

2. Description of Related Art

Conventionally, Eggs Benedict are prepared by poaching eggs in an egg poacher or by dropping the eggs directly in heated water. The hollandaise sauce or like sauce is prepared by using a double boiler or other separate utensil for preparing the sauce in a well known manner. Various methods for making hollandaise sauce are well known and may be found in many sources, for example, in Wikipedia for hollandaise sauce incorporated by reference herein.

### SUMMARY OF THE INVENTION

The present invention is a combined egg poacher and sauce-making utensil having a pan for holding the water to be heated and a perforated steamer plate or rack positioned in the pan spaced above the surface of the water in the pan. The perforated steamer plate holds removable egg cups for poaching eggs in a conventional manner. In one embodiment, a central portion of the steamer plate has a hole formed therethrough for receiving a sauce bowl removably positioned in the hole. The sauce bowl has a lid positioned thereon. A large main lid, which may be dome-shaped, then covers the entire array of egg cups and the sauce bowl with its lid. In another preferred embodiment, the sauce bowl may be formed integrally with the main lid, or conversely, the main lid may have a central aperture formed therethrough for receiving a separate sauce bowl and lid in the top of the main lid. In these arrangements, the hollandaise sauce or other sauce may be prepared separately while using the sauce bowl and then the eggs may be poached at a different time because the sauce generally takes longer to prepare than the cooking of the eggs.

### BRIEF DESCRIPTION OF THE DRAWINGS

FIG. 1 is an exploded view of the various parts of the combined egg poacher/sauce-making utensil of the present invention;

FIG. 2 is a perspective view of the combined egg poacher/sauce maker of the present invention in one presently preferred embodiment;

FIG. 3 is a plan view of the egg poacher of FIG. 2 with the lid removed;

FIG. 4 is a cross-sectional view of the egg poacher depicted in FIGS. 1-3;

FIG. 5 is an exploded perspective view of a further presently preferred embodiment of the present invention;

FIG. 6 is yet another presently preferred embodiment of the present invention shown as an exploded perspective view; and

FIG. 7 is a cross-sectional view of the assembled combined egg poacher/sauce maker of the embodiment of FIG. 6.

### DETAILED DESCRIPTION OF THE INVENTION

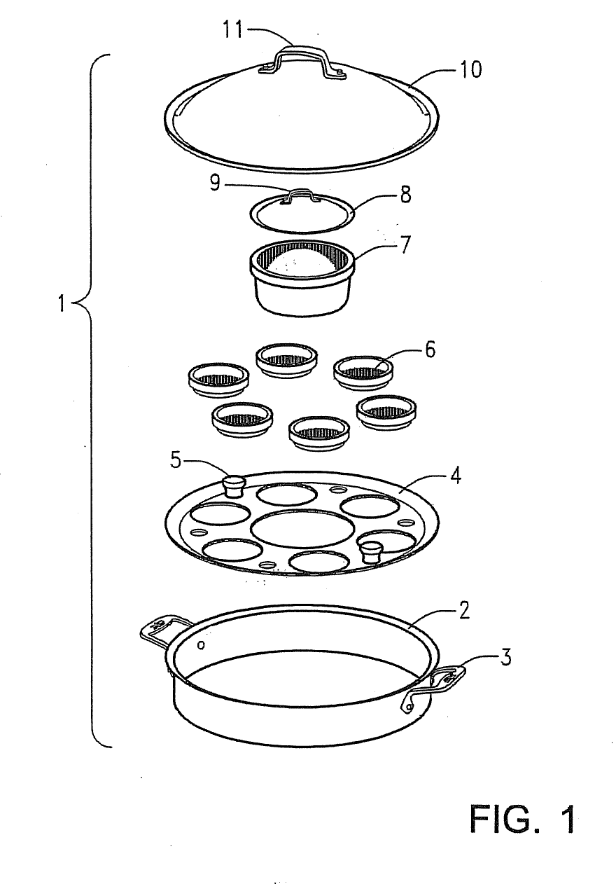

As shown in FIG. 1, a combined egg poacher/sauce-making utensil 1 with a pan bottom, pan 2, side loop handles 3, perforated steamer plate/rack 4, knob handles 5 located on the steamer plate, egg cups 6, sauce bowl 7, small lid 8 for the sauce bowl 7, handle 9 for the lid 8 on the sauce bowl 7, a large domed lid 10 for the pan 2, and a handle 11 for the large lid 10.

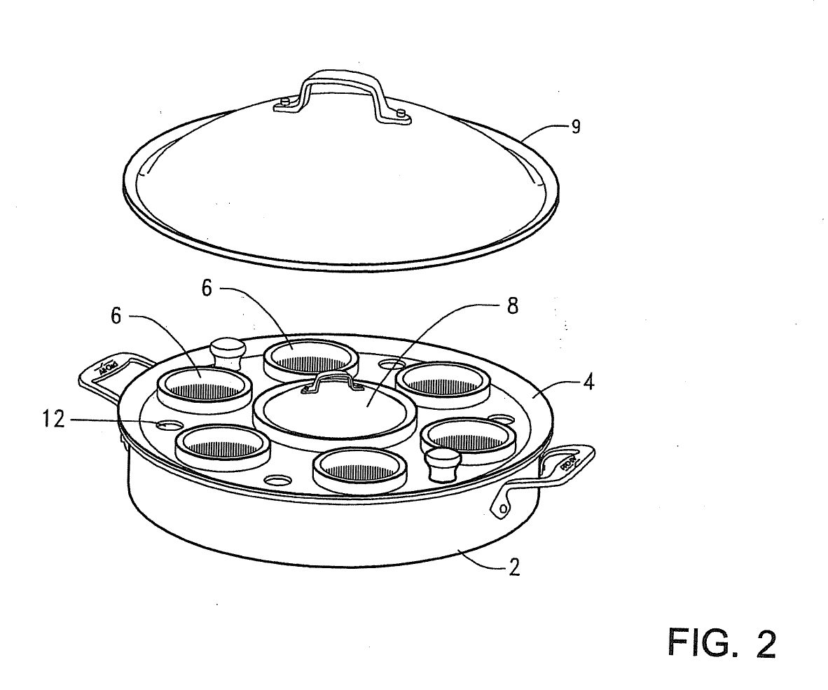

As shown in FIG. 2, a view of the assembled invention showing steam holes 12 in the steamer plate 4 and knob handles 5 fastened to the steamer plate 4 to permit handling of the steamer plate 4.

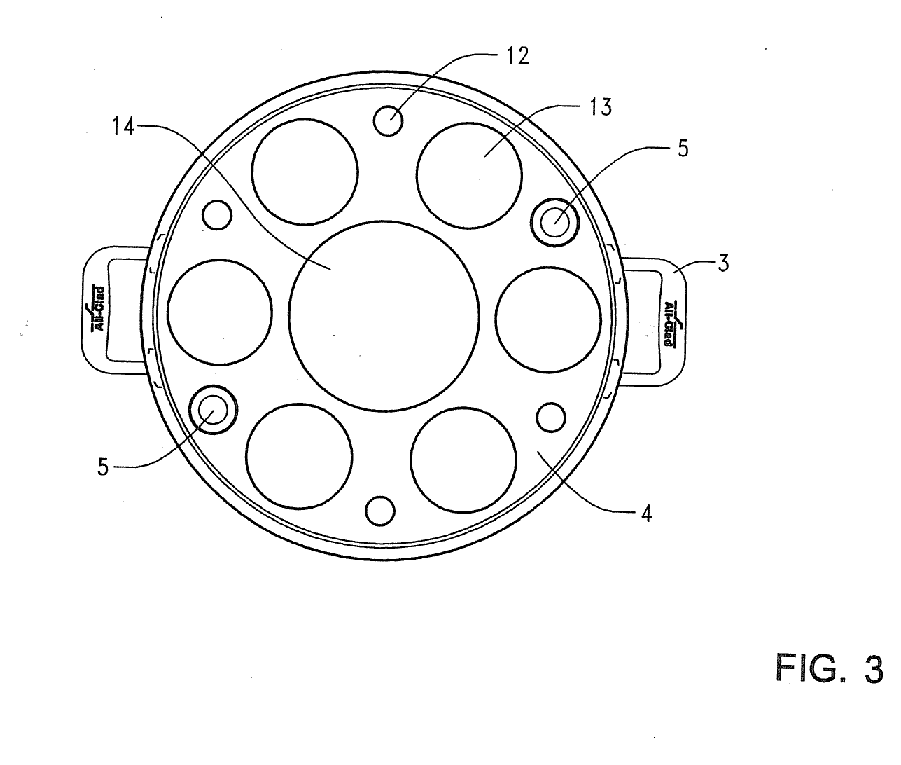

As shown in FIG. 3, the steamer plate 4 hole pattern showing egg cup holes 13, and sauce bowl hole 14.

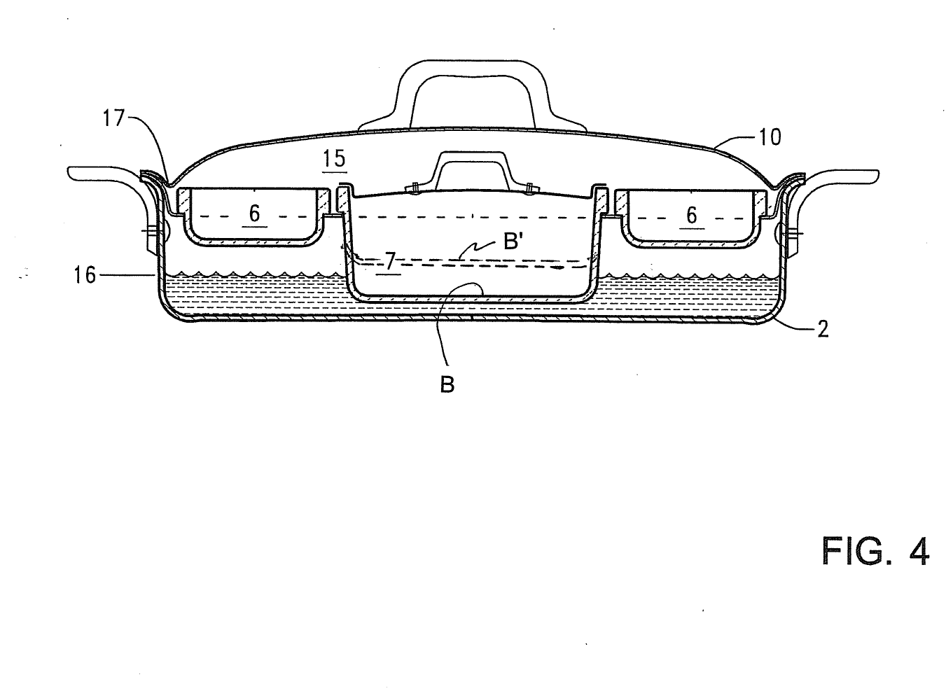

As shown in FIG. 4, a sectional view showing area 15 under the domed lid 10 for steam collection and water level 16 at a specifically designed height that allows egg cups 6 to be above the hot water, while the sauce bowl 7 acts as a double boiler. The location 17 of the lid 10 and steamer plate, and the fitted shape, allow lid condensate from the steam to drip and fall outside of the egg cups 6.

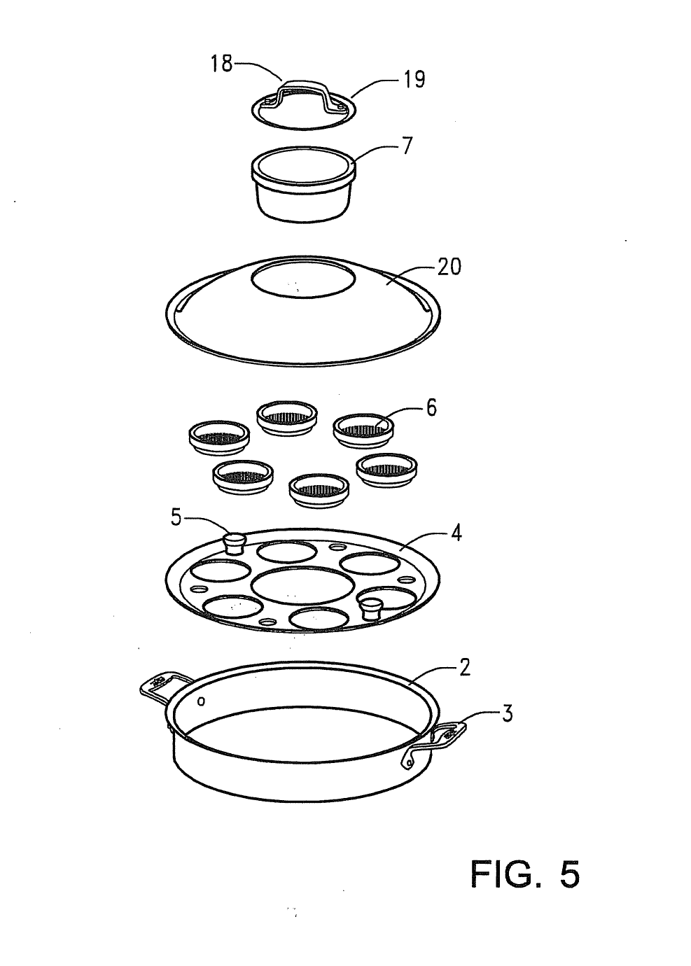

As shown in FIG. 5, an alternate lid 20 design showing a sauce bowl lid 19, a handle 18 for the sauce bowl lid 19, and large domed lid 20 with sauce bowl opening 20′. The handle 18 for the sauce bowl lid 19 may optionally serve as the handle for the domed lid 20, or the domed lid 20 may have attached thereto a separate handle (not shown). In this embodiment the domed lid 20 has a hole 20′ cut through at its top to permit placement of the sauce bowl 7 to fit therein and come to rest on the enlarged top rim formed around the sauce bowl 7. The lower portion of the bowl 7 is dimensioned such that it extends through the hole 14 formed in the steamer plate/rack 4.

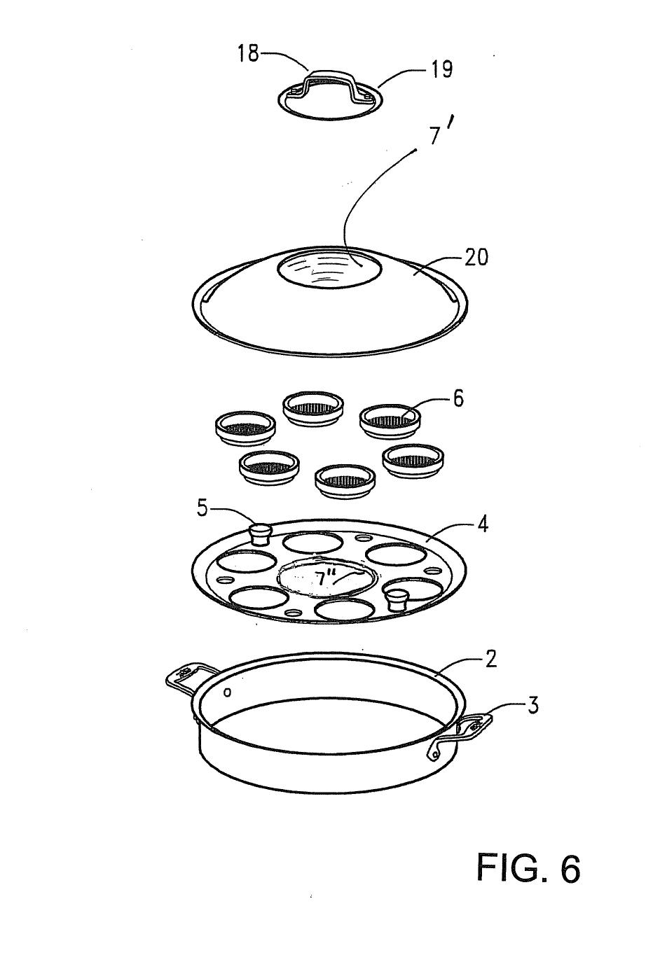

FIG. 6 depicts a further embodiment in which the sauce bowl 7′ is integrally formed in the top of the domed lid 20, with a lid 19 for the sauce bowl 7′ having a handle 18 fitted thereon. The handle 18 for the sauce bowl lid 19 may optionally serve as the handle for the domed lid 20, or the domed lid 20 may have attached thereto a separate handle (not shown).

The present invention promotes ease and convenience in the preparation of poached eggs while minimizing energy consumption, minimizing ambient heat in a kitchen, and provides for fewer cooking utensils to be in use while making poached eggs. It features a shallow pan that is large in diameter to cook poached eggs but has a high domed lid with, optionally, a hole in the middle that accepts a separate sauce bowl that acts as a steamer insert for preparation of sauces. The domed lid may also feature a recessed middle that is not separable from the domed lid and is also used for preparation of sauces.

Description of Parts:

1. Pan 2—typical egg poacher base.

2. Support rack/steamer plate 4 made of metal holds four to ten egg cups 6, depending on the size of the unit.

3. Egg cup 6—made from stainless steel, ceramic, carbon steel, or aluminum and may feature a bare food preparation surface or be coated with non-stick material.

4. Domed lid 10, 20—can be glass, ceramic or metal such as polished stainless steel, optionally features handles, and fits securely on the interior perimeter of the pan 2. In one embodiment, a hole 20′ that closely matches the diameter of the sauce bowl 7 is in the center of the lid 20. In one embodiment, shown in FIG. 5, the depth of the lid 20 is high enough that the lid 20 easily clears the egg cups 6 that are in the steamer plate 4. In another embodiment, the lid 20 features an integral recess 7′ in the middle in place of the hole 20′ and the recess 7′ acts as a non-removable sauce bowl, as shown in FIG. 6. In yet another embodiment, shown in FIG. 1, the domed lid 10 does not contain a hole or a recess and the depth of the lid 10 is high enough that the lid 10 clears the egg cups 6 and the sauce bowl 7 when they are placed in the steamer plate 4.

5. Sauce bowl 7, 7′—used for preparation of sauces, and may be glass, ceramic or metal with or without non-stick. The sauce bowl 7 may be removable or integrally formed with the domed lid. The body of the removable sauce bowl 7 may feature a ring or rim that prevents it from dropping through the hole 20′ in the lid 20 beyond the desired depth and/or through the hole 14 in the steamer plate 4. The sauce bowl 7 can be equipped with finger grip recesses or handles for ease of removal from the lid 20. In another embodiment, the sauce bowl 7′ can be an integral part of the domed lid 20, in which case it would not be removable.

6. Sauce bowl lid 8, 19—may be made of glass, ceramic or metal and, in one embodiment, will fit on the hole 20′ in the domed lid 20. This lid may also feature a handle 9, 18 for easy removal.

Advantages of the Product:

1. Uses one burner instead of two while simultaneously preparing poached eggs and sauces, resulting in energy efficiency and less ambient heat in the food preparation area.

2. Fewer utensils involved in food preparation, resulting in greater ease of cooking and cleaning.

3. Appealing to the consumer in that one product offering completely satisfies the equipment needs for this cooking activity.

In one embodiment, shown in FIG. 4, the sauce bowl 7 may protrude beneath the surface of the water 16 in pan 2, as shown with bottom “B” or, conversely, if so desired, the sauce bowl 7 may have a bottom B′ formed thereon which resides in a spaced relation to the water level 16 in pan 2. This is due to a discrepancy in how some cooks prefer to make the sauce, i.e., with the sauce bowl immersed in the water or spaced above the water as in a double boiler.

In the embodiment shown in FIG. 5, the sauce bowl 7 is merely inserted into an orifice formed in the top of the main lid 20 having a lid 19 fitted thereto with a lifting handle 18 provided.

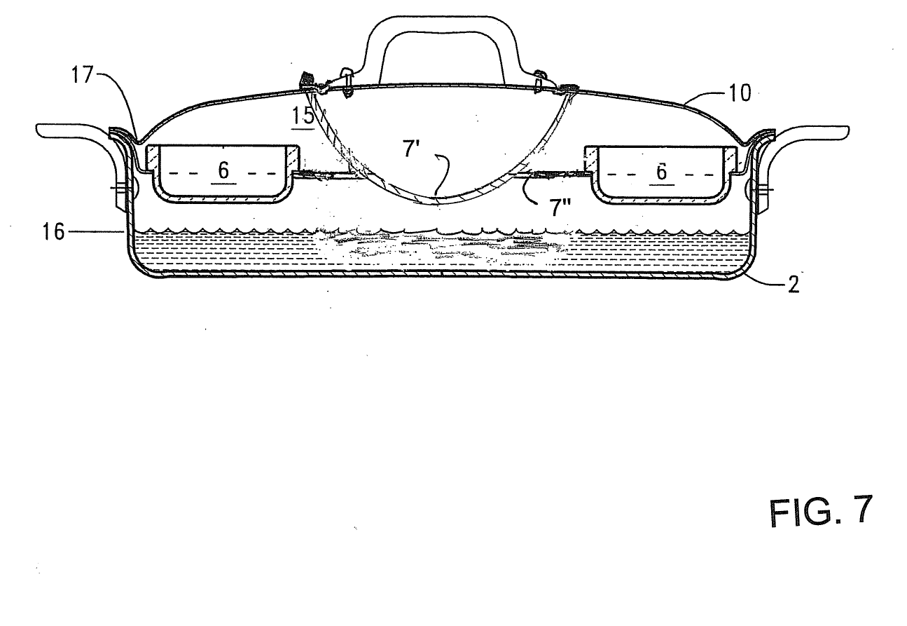

Alternately, as shown in FIG. 6, the lid 20 has a sauce bowl 7′ integrally formed therein with a lid 19 and handle 18 provided. A large diameter orifice 14 is formed in the steamer plate 4 to permit the sauce-making bowl 7′ to depend downwardly therethrough but spaced above the water level as shown in FIG. 7. The lid 20 also may have a handle (not shown) attached thereto for easy removal and placement of the lid 20 on the pan 2.

The invention claimed is:

1. A combined egg poacher and sauce making utensil, comprising:
a pan comprising a flat, closed bottom end and an open top end;
a rack comprising a plurality of openings of a first diameter and a single opening of a second diameter;
a plurality of egg cups comprising a closed bottom end, an open top end, an outer rim, and a hollow cup body extending between the closed bottom end and the open top end;
a dome-shaped pan lid that at least partially encloses the open top end of the pan;
a sauce preparation bowl comprising a closed bottom end, an open top end, and a hollow sauce bowl body extending between the closed bottom end and the open top end, said sauce preparation bowl formed either separately or integral with the dome-shaped pan lid; and
a sauce bowl lid that substantially encloses the open top end of the sauce preparation bowl.

2. The utensil of claim 1, wherein the single opening of the second diameter is disposed in the center of the rack.

3. The utensil of claim 1, wherein the cup body has a diameter that is smaller than the first diameter.

4. The utensil of claim 3, wherein the outer rim of the cup engages the rack when the cup is inserted into an opening of the first diameter.

5. The utensil of claim 4, wherein the outer rim of the cup is disposed at the open end of the cup.

6. The utensil of claim 1, wherein the sauce bowl is integrally formed with the pan lid.

7. The utensil of claim 1, wherein the sauce bowl comprises an outer rim.

8. The utensil of claim 7, wherein the sauce bowl body has a diameter that is smaller than the diameter of the single opening of the rack.

9. The utensil of claim 8, wherein the outer rim of the sauce bowl engages the rack when the sauce bowl is inserted into the single opening of the rack.

10. The utensil of claim 9, wherein the outer rim of the sauce bowl is disposed at the open top end of the sauce bowl.

11. The utensil of claim 1, wherein the pan lid comprises a centrally disposed aperture which removably receives the sauce bowl.

12. The utensil of claim 11, wherein the sauce bowl body has a diameter that is smaller than the aperture.

13. The utensil of claim 12, wherein the sauce bowl comprises an outer rim and the outer rim engages the aperture when the sauce bowl is inserted into the aperture.

14. The utensil of claim 13, wherein the outer rim of the sauce bowl is disposed at the open top end of the sauce bowl.

15. The utensil of claim 1, wherein the rack further comprises a plurality of holes of a third diameter.

16. The utensil of claim 15, further comprising a handle disposed in at least one of the holes of the third diameter.

17. The utensil of claim 1, wherein the pan lid completely encloses the open top end of the pan.

18. The utensil of claim 1, wherein the rack is removable from the pan.

19. The utensil of claim 1, wherein the cups are removable from the rack.

20. A method of cooking an egg meal, comprising the steps of:
a) providing a combined egg poacher and sauce making utensil comprising:
a pan comprising a flat bottom end and an open top end,
a rack comprising a plurality of openings of a first diameter and a single opening of a second diameter,
a plurality of cups comprising a closed bottom end, an open top end, an outer rim, and a hollow cup body extending between the closed bottom end and the open top end,
a dome-shaped pan lid that at least partially encloses the open top end of the pan,
a sauce preparation bowl comprising a closed bottom end, an open top end, and a hollow sauce bowl body, and
a sauce bowl lid that substantially encloses the open top end of the sauce preparation bowl,
b) partially filling the pan with a liquid;
c) placing the contents of at least one egg in at least one of the cups;
d) placing a sauce in the sauce preparation bowl;
e) inserting the sauce preparation bowl into the single opening of the second diameter; and
f) placing the utensil over a heat source.
